(19) United States
(12) Patent Application Publication
(10) Pub. No.: US 2021/0212420 A1
(43) Pub. Date: Jul. 15, 2021

(54) WRISTBAND

(71) Applicant: ESKI Inc., Montreal (CA)

(72) Inventors: Vincent Leclerc, Montreal (CA); Ren Ren, Montreal (CA); Olivier Mayrand, Montreal (CA); Remi D. Senechal, Montreal (CA); Alexandre Martel, Laval (CA)

(73) Assignee: ESKI Inc., Montreal, QC (CA)

(21) Appl. No.: 17/124,129

(22) Filed: Dec. 16, 2020

Related U.S. Application Data
(60) Provisional application No. 62/961,002, filed on Jan. 14, 2020.

(51) Int. Cl. A44C 5/20; A44C 5/00

(52) U.S. Cl. CPC A44C 5/2071; A44C 5/0015

(57) ABSTRACT

A wristband adapted to be worn by a wear includes a housing arranged to store one or more electronic components, a first band segment attached to a first portion of the housing, and a second band segment affixed to a second portion of the housing. The wristband may be formed of a material or composite which is recyclable and/or compostable, reducing the environmental impact of using the wristband to produce a distributed manifestation. The first and/or second band segments includes a mechanical feature allowing the wristband to comfortably encircle a wearer's wrist.

### RELATED APPLICATION

This application claims the benefit under 35 U.S.C. § 119(e) of the filing date of commonly assigned U.S. Provisional Patent Application Ser. No. 62/961,002, entitled “Wristband,” filed on Jan. 14, 2020, having Attorney Docket No. E0499.70014US00, the entirety of which is incorporated herein by reference.

### BACKGROUND

Commonly assigned U.S. Pat. No. 8,740,391 (hereinafter “the '391 patent,” which is incorporated herein by reference) discloses a system for providing a distributed manifestation within an environment. The system may include a number of receiving units distributed throughout the environment. Each receiving unit may manifest a state change in response to receiving one or more signals from one or more transmitters in the environment. For example, in response to receiving a signal, a receiving unit may create a visual display (e.g., by changing color, displaying video or an image, emitting light, etc.) and/or produce effects which involve sound, shape, odor and/or other sensory stimuli. State changes may be for a fixed period of time, or dynamic (e.g., receiving units may change state in real time, or may be perceived to do so). A receiving unit may, for example, comprise a wearable device (i.e., a device or collection of components designed to be worn by an attendee at an event). One example of a wearable device is a wristband.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a wristband according to some embodiments of the present disclosure;

FIG. 2 is another perspective view of the wristband of FIG. 1, with a cover a housing shown removed;

FIG. 3 is a side view of the wristband of FIG. 1;

FIG. 4 is a bottom view of the wristband of FIG. 1;

FIG. 5 is an enlarged cross-sectional side view of a portion of the wristband of FIG. 1;

FIG. 6 is a side view of the wristband of FIG. 1;

FIG. 7 is an enlarged view of a portion of the wristband in a circle labeled 7 in FIG. 6;

FIG. 8 is a bottom view of a wristband according to some embodiments of the invention;

FIG. 9 is a bottom view of a wristband according to some embodiments of the invention;

FIG. 10 is a bottom view of a wristband according to some embodiments of the invention;

FIG. 11 is a bottom view of a wristband according to some embodiments of the invention, with a cover shown in an open position;

FIG. 12 is the wristband of FIG. 11, with the cover shown in a closed position;

FIG. 13 is a wristband according to some embodiments of the invention, with covers shown in open positions;

FIG. 14 is the wristband of FIG. 13, with the covers shown in closed positions; and

FIG. 15 shows a wristband according to some embodiments of the invention.

### DESCRIPTION

Conventionally, a receiving unit consisting of a wristband includes a housing which stores electronic components (e.g., a receiver for receiving signals from one or more transmitters, a power source, circuitry for processing the signals, and/or one or more state changing components), and one or more band segments affixed to the housing. For example, a wristband may include first and second band segments which cooperate (e.g., attach or fasten together) to fully or partially encircle a wearer's wrist. The housing and band segments are typically formed together, as a unitary apparatus, using conventional injection mold techniques, although any suitable technique(s) may be employed.

Although wristbands are typically designed to be reusable, wearers will often dispose of them after an event, generating excess waste. The Assignee has recognized the desirability of reducing the environmental effects of using wristbands to produce distributed manifestations, such as by making the wristbands from materials which can be recycled and/or composted. However, the Assignee has also recognized that materials which are recyclable and/or compostable (and composites comprising materials which are recyclable and/or compostable) typically possess physical characteristics which make them unsuitable for use in forming wristbands using conventional injection molding techniques. In this respect, the Assignee's research with various recyclable and/or compostable materials (and composites comprising recyclable and/or compostable materials) has revealed that many materials and composites are too hard as to comfortably bent around a wearer's wrist, some are so brittle or inflexible as to snap easily when worn, and some are prone to becoming stuck to a mold when injected. Some are prone to degradation, scratch easily, and/or are insufficiently transparent (which may affect the wristband's ability to produce a visual display).

Some embodiments of the invention are directed to techniques for producing a wristband suitable for creating a distributed manifestation, from materials which can be recycled and/or composted, using injection molding techniques. In accordance with some embodiments, a wristband may be formed of a material or composite with sufficient hardness as to resist scratching and degradation, and resists discoloration. For example, some embodiments of the invention may employ a material or composite having a hardness (as measured using a durometer) of about 50. Some embodiments may have a hardness of between 45 and 70. Some embodiments may employ a material or composite having a particular rigidity and/or stiffness.

To enable a wristband formed of such a material or composite to be comfortably bent around a wearer's wrist, some embodiments may employ one or more mechanical elements to achieve sufficient flexibility. For example, in some embodiments, one or more depressions or cavities may be formed in the surface of a band segment, thereby creating portions of the segment which are thinner than other portions, and thus more flexible. These portions may serve as a pliable, but strong, connections between other, thicker portions of the band segment in which depressions or cavities are not formed. Any of numerous techniques may be used to produce depressions or cavities which may be used for this purpose. For example, some embodiments may involve creating one or more living hinges. Some embodiments may involve creating one or more auxetic patterns. Any suitable type of depressions or cavities (hereinafter referred to as “depressions,” for brevity) may be used for this purpose.

In some embodiments, depressions formed in first and second band segments may consist of channels. The channel(s) may be formed on one side of each of the first and second band segments, such as on an outwardly facing side which opposes the side adapted to contact a wearer's wrist. Of course, one or more channels may be formed on an inwardly facing side, or on both inwardly and outwardly facing sides. The side(s) on which channels are formed may vary from band segment to band segment.

In some embodiments, a channel may extend along at least a portion of a width of each band segment, at least part way between a first edge of the band segment and a second edge of the band segment. In some embodiments, the channel extends the entire distance between the first and second edges. A channel may extend continuously from the first edge to the second edge, or include one or more channel segments which each extend part of the way between the first and second edges.

In some embodiments, each band segment may include multiple depressions along its length. The depressions may be somewhat evenly spaced along the entire length of each band segment, or may be concentrated in one or more particular portions of each band segment. Any suitable number of depressions may be used in each band segment to impart sufficient flexibility to the wristband.

In this respect, the inventors have recognized that using too many depressions may result in a wristband which is too brittle and may snap easily, while using too few may result in a wristband which is too uncomfortable to be worn. In some embodiments, then, each band segment includes twelve to fifteen depressions which are relatively equally spaced from the distal and proximal ends of the band segment. In some embodiments, the depressions are spaced about 5 mm apart. In some embodiments, the depressions may be spaced between 2 mm and 20 mm apart. Of course, the length of a band segment, and the spacing of depressions on the band segment, may affect how many depressions are on the band segment. Each band segment may include any suitable number of depressions may be used, at any suitable spacing, along any suitable length.

In some embodiments the band segment(s) and at least a portion of the housing for storing electronics is formed as a unitary or monolithic article (e.g., via a mold). For example, in some embodiments, a front or back portion of the housing may be formed as a unitary article with first and second band segments, and this front or back portion of the housing may mate with a separately formed portion to create a cavity for storing electronics. In some embodiments, the band segment(s) and at least a portion of the housing may be fixedly attached. As will be appreciated, in some embodiments, the band segment(s) also may be removable from and/or attachable to the at least a portion of the housing.

In some embodiments, the housing may be formed to achieve various design objectives. As one example, the housing may be formed with safety concerns in mind, such as to require multiple steps to open it once it is closed. For example, in some embodiments, even after releasing a closure mechanism fastening one portion of the housing to another, a tool may be required to open the housing, to prevent children from easily accessing batteries stored in the housing.

It should be appreciated that the invention is not limited to separately forming portions of the housing. For example, in some embodiments, both front and back portions of the housing may be formed as a unitary article with first and second band segments, with the front and back portions being hingedly connected or fastened.

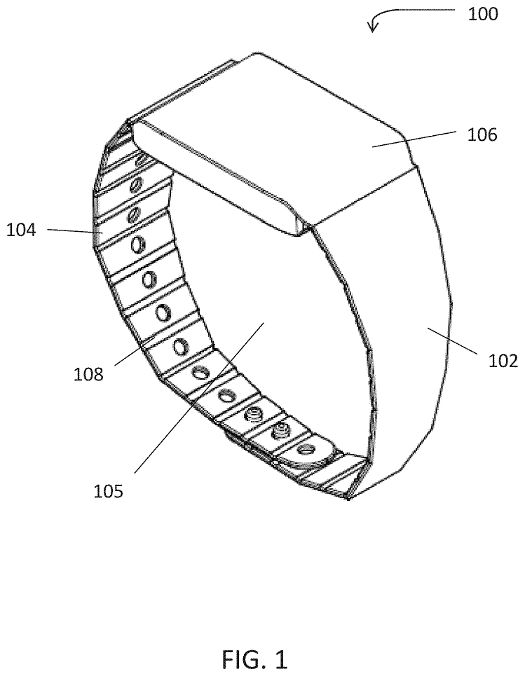

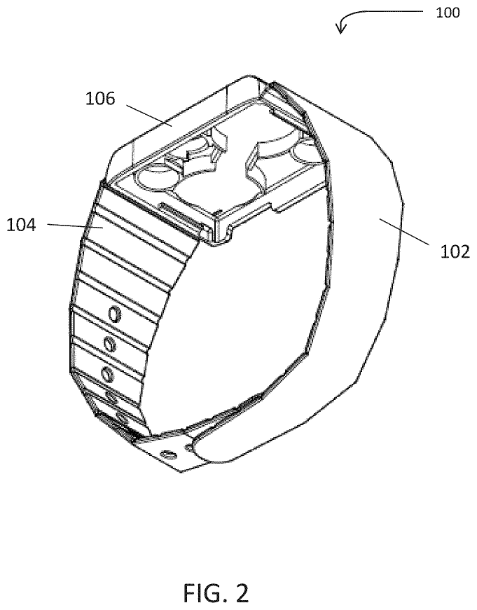

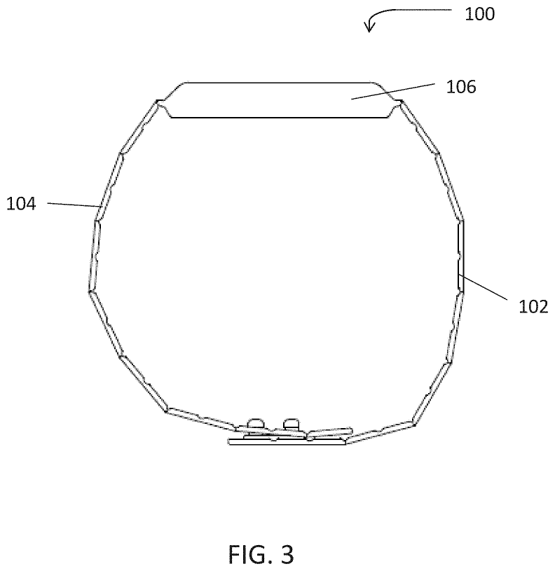

FIGS. 1-3 depict a representative wristband 100 implemented in accordance with some embodiments of the invention. Representative wristband 100 includes first and second band segments 102, 104 which cooperate to encircle a wearer's wrist. In the embodiment shown, the first and second band segments 102, 104 include implements (described further below) which allow the band segments to be attached about a wearer's wrist. However, it should be appreciated that the invention is not limited to employing such implements, or to being attached or fastened about a wearer's wrist, and may fully or partially encircle a wearer's wrist, in any suitable fashion. In some embodiments, as shown in FIGS. 1 and 4-5, each of the first and second band segments 102, 104 may include depressions 108 which impart flexibility and allow the first and second band segment to cooperate to encircle a wearer's wrist. In some embodiments, each depression consists of a channel formed in a first side 109 of a band segment, between first and second edges 110, 112 of the segment (see, e.g., band segment 102). In the example shown, the first side is adapted to contact the wearer's wrist. Of course, as discussed above, depressions 108 may be formed on any suitable side (e.g., a second side which opposes the one adapted to contact the wearer's wrist), or on both sides.

Although both the first and second band segments are shown with one or more depressions in these embodiments, in some embodiments, only the first band segment or only the second band segment may include channels to impart flexibility.

Although a channel is shown as extending continuously between the first and second edges of the band segment, in other embodiments, the channel may extend only partially between the first and second edges of the band segment. In some embodiments, a channel may consist of one or more discrete channel segments which together extend at least part of the way between the first and second edges. In embodiments which employ channel segments, each channel segment may be the same length, or the length may vary from segment to segment. Each channel segment may be the same shape, or may vary from segment to segment.

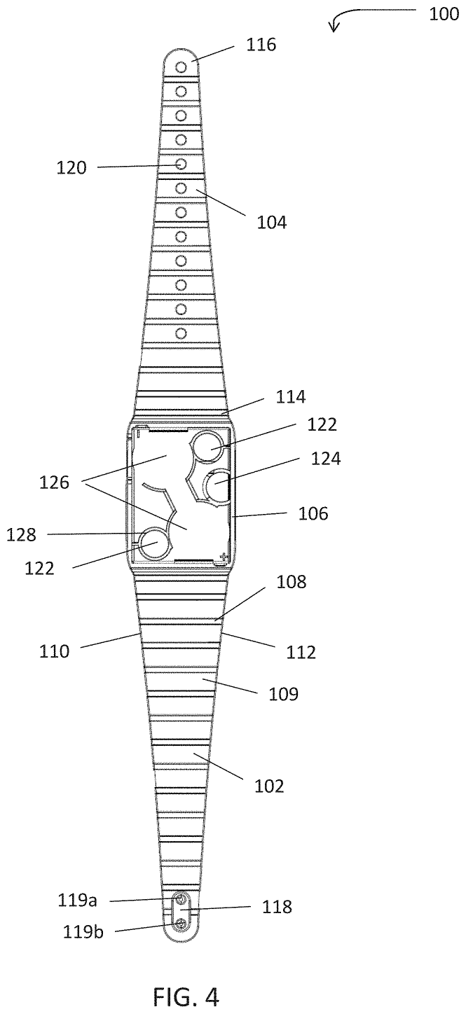

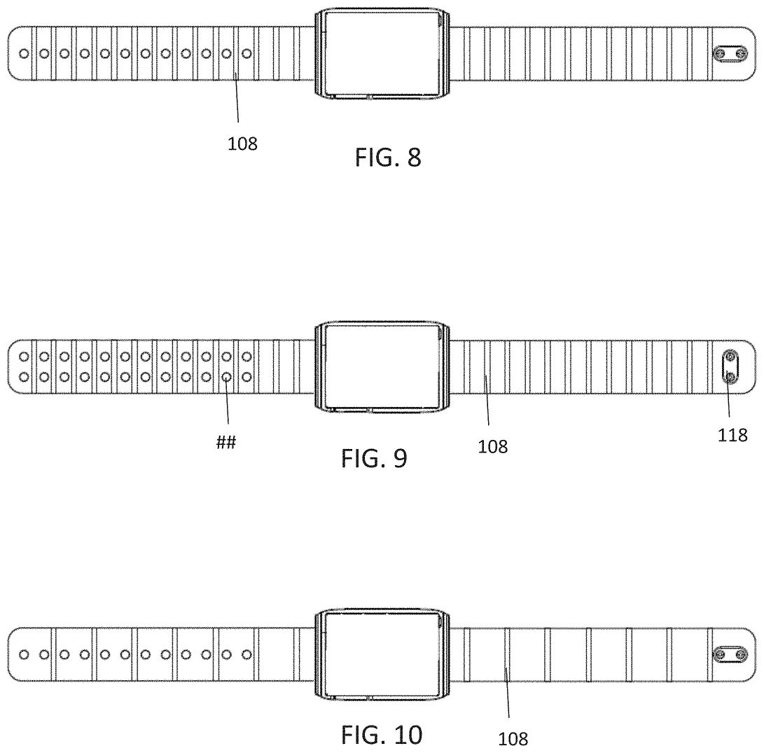

In some embodiments, the length of each channel may be the same from channel to channel. For example, as shown in FIGS. 8-10, where the width of each band segment is the same, the length of each of the channels is the same. In other embodiments, the length of the channel may vary from channel to channel. For example, as shown in FIG. 4, where the width of the band segment decreases from the proximal end 114 to the distal end 116, the length of the channel at or near the proximal end is larger than that of the channel near the distal end. As will be appreciated, the channels need not be different lengths in embodiments in which the width of the band decreases from the proximal end to the distal end. For example, in other embodiments, the length of all the channels may be the same, with the channels extending only partially between the first and second edges of the band segment near the proximal end of the band while extending all the way between the edges of the band near the distal end.

In some embodiments, a plurality of channels may be formed between the proximal and distal ends of each of the band segments. In some embodiments, the channels may be equally spaced between the distal and proximal ends. In other embodiments, relatively more channels may be concentrated near only the proximal end, or near only the distal end, or in one or more particular regions between the proximal and distal ends of the band segment.

Although the channels in the examples shown extend roughly parallel to each other, in a direction roughly parallel to the edge of the housing 106 to which a band segment is attached, the invention is not limited to such an implementation. For example, any channel(s) in a band segment may extend in a direction which is not parallel to another channel, and/or not parallel to an edge of the housing. Any of numerous channel designs and/or patterns may be envisioned, and are considered within the scope and spirit of the invention.

In some embodiments, as shown in FIG. 4, each band segment may include between five and twenty channels. In some embodiments, as shown in FIG. 10, each band segment includes seven channels. In some embodiments, as shown in FIG. 4, each band segment includes fourteen channels. Any suitable number of channels may be employed, in each band segment.

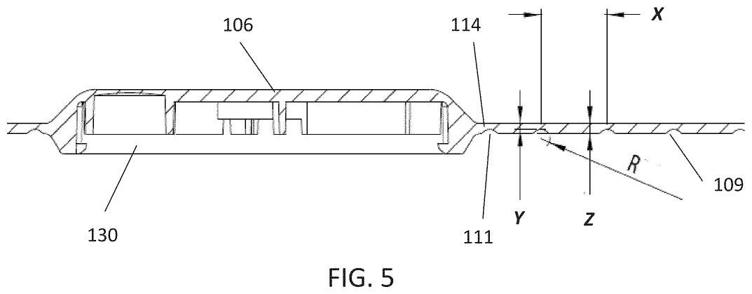

In some embodiments, the channels may be spaced (see the arrow labeled X in FIG. 5) between about 4 mm and about 25 mm from one another. For example, in some embodiments, the channels may be spaced between about 5 mm apart.

As will be appreciated, the length, number, and spacing the channels may be the same on both band segments, or may be different from band segment to band segment. For example, in some embodiments, the first band segment may include ten depressions that are equally spaced from one another, and of the same length, while the second band segment includes only five depressions that are different lengths, and all positioned near a central portion of the band segment. The channels may have other suitable arrangements in other embodiments.

In some embodiments, a channel 111 may be formed at the proximal end 114 of each band segment, where the band segment attaches to the housing 106. In some embodiments, such a channel may allow the band segment to be moveable relative to housing. As will be appreciated, other suitable arrangements may be employed where the band segment attaches to the housing to allow the band segment to move relative to the housing.

In some embodiments, as shown in FIG. 5, the channel may have a substantially semi-hemispherical shape when viewed in cross-section. Of course, any channel may have any suitable shape. For example, in some embodiments, a given channel may have a square, triangular, circular, oval, other polygonal, or other cross-sectional shape. In embodiments in which the channel has a substantially semi-circular cross-sectional shape (see, e.g., FIG. 5) and the band segment has a thickness of about 1 mm, the channel may have a radius R of, for example, approximately 0.5 mm. Of course, the radius of a semi-circular channel may vary based on the thickness of a band segment, and the material or composite from which the wristband is formed.

In some embodiments, the depth Y of the channel is between about 0.2 mm and about 1 mm. For example, in some embodiments, the depth of the channel may be about 0.5 mm. In such embodiments, the thickness of the wristband Z (see FIG. 5) may be between about 0.75 and about 1.5 mm thick. For example, the thickness of the wristband may be about 1 mm thick. In such embodiments, the ratio between the thickness of the wristband and the depth of the channel may be between about 1.5 and about 7.5.

As shown in FIG. 4, the width of each of the first and second band segments may decrease between the proximal end and the distal end. In some embodiments, the width of each band segment may taper between the proximal and distal ends. The width also may decrease in another fashion, such as in a stepwise fashion between the distal and proximal ends. In some embodiments, a width of the distal end of the band segment may be between about one third and about one half of a width at the proximal end of the band segment. In some embodiments, the width of the band segment may be about 1.5 mm. In some embodiments, the width of the band segment may be between 1 mm and 3 mm.

In some embodiments, first band segment 102 is attachable to second band segment 104. In the example shown, first band segment 102 includes a clip 118 with first and second pins 119a, 119b that are insertable into corresponding openings 120 in the second band segment 104 (see FIG. 4). As will be appreciated, the size of the wristband may be adjustable by inserting the pins into different openings along the second band segment. For example, by inserting pins 119a, 119b into openings closer to the proximal end 114 of second band segment 104, the wearer may make the wristband shorter, and by inserting pins 119a, 119b into openings closer to the distal end 116 of second band segment 104, the wearer may make the wristband longer.

It should be appreciated that although the clip is shown on the first band segment for being attachable to the corresponding openings on the second band segment, in other embodiments, the clip may be on the second band segment for inserting into openings on the first band segment. It should also be appreciated that although the pins and corresponding holes shown are substantially circular in shape, pins and corresponding holes may have any suitable shape (e.g., oval, triangular, square, other polygonal, etc.). It should further be appreciated that although the embodiments shown depict the pins projecting toward the wearer's wrist when the first and second band segments are attached, the invention is not limited to such an implementation, and may allow for the pins to project away from the wearer's wrist when the first and second band segments are attached.

In some embodiments, as shown in FIG. 4, the clip and pins may be aligned with a longitudinal axis of the wristband. In such embodiments, the openings may be aligned in a column, with the pins being insertable into openings in adjacent rows. In other embodiments, as shown in FIG. 9, for example, the clip and pins may be arranged substantially perpendicular to the longitudinal axis of the wristband. As shown in this view, the second band segment may include two openings in each row, with the pins being insertable into both openings during attachment (see FIG. 4). As will be appreciated, the wristband may have other suitable mechanisms for attaching the first and second band segments in other embodiments.

Housing 106 is adapted to store one or more electronic components. As examples, housing 106 may store one or more batteries, a receiver, one or more light sources (e.g., LEDs), and/or other components. In some embodiments, as shown in FIG. 4, housing 106 may include compartments arranged to receive specific components. For example, compartments 122 may be designed to store LEDs, compartment 124 may be designed to store a receiver, and compartments 126 may store batteries. Compartments may be any suitable shape, such as to correspond with the shape of a corresponding electronic component (e.g., in FIG. 4, compartments 126 are substantially cylindrical in shape to accommodate batteries of cylindrical shape). Compartments may, for example, be formed by one or more divider walls 128. Of course, the shape and size of each divider wall may vary, and correspond to the shape and size of a corresponding compartment. For example, as shown in FIG. 4, a generally tubular-shaped wall 128 is used to form the cylindrical-shaped compartment 122 for the LEDs. In some embodiments, a thickness of a wall of the housing may be between about 0.3 mm and about 1.0 mm.

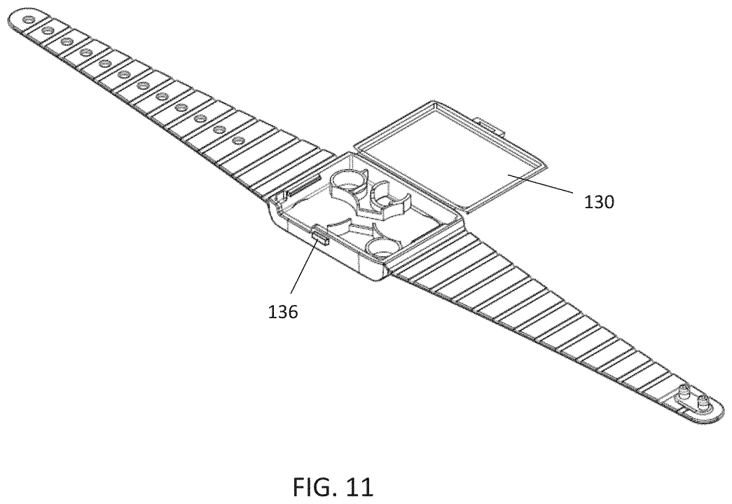

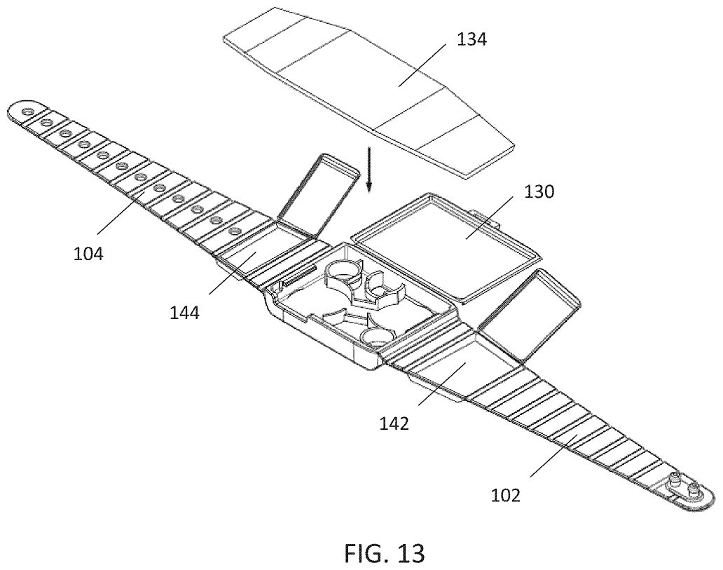

In some embodiments, as shown in FIG. 5, the housing includes a cover 130 to hold electronic components within the housing. In some embodiments, such as that shown in FIG. 5, circuitry may be attached to the cover. In other embodiments, such as those shown in FIGS. 11 and 13, circuitry may be insertable into at least a portion of the housing that is closed using a separate cover.

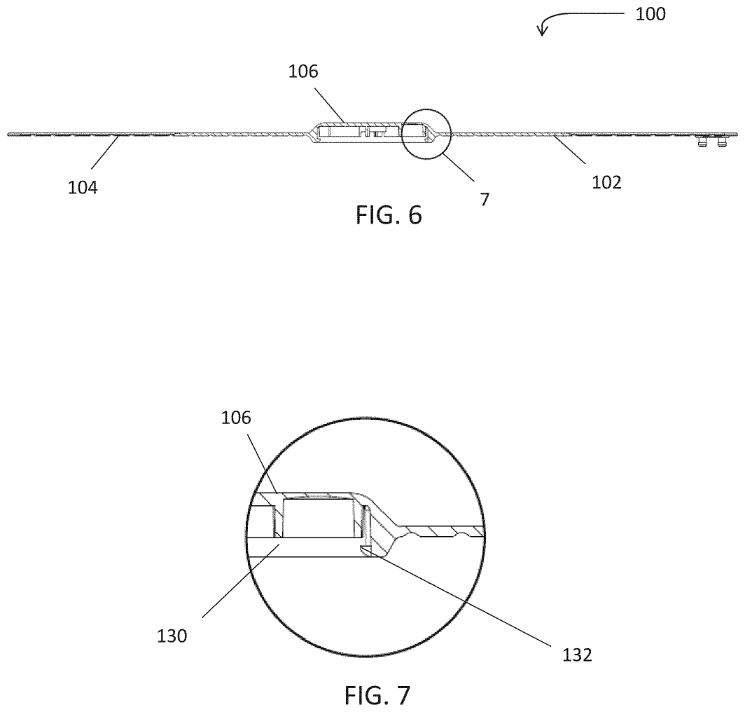

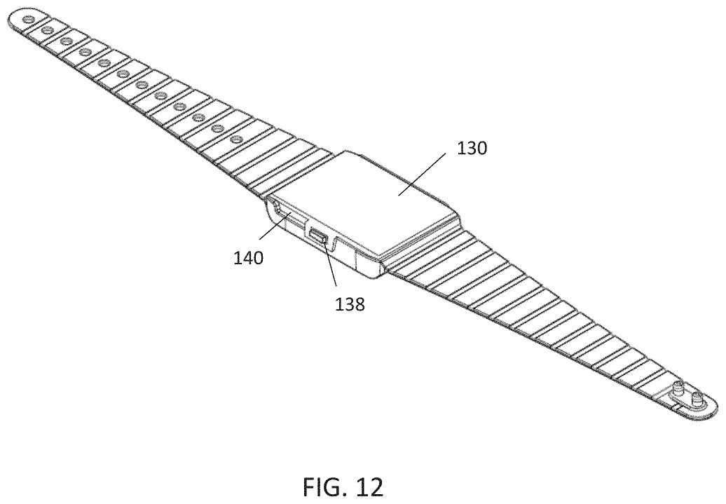

In some embodiments, a cover may be snap-fit to a base of the housing. For example, as shown in FIGS. 6 and 7, one of the cover or base may include a fastener 132 which engages with the other of the cover or base. In some embodiments, fastener 132 splays outwardly upon insertion, attaching the cover and base. In other embodiments, as shown in FIGS. 11-12, the cover may hingedly attach to the base of the housing and close using an opening 138 which engages with a clip 136. Any suitable mechanism(s) may be employed to attach a cover onto a base of the housing.

In some embodiments, the wristband includes child safety measures to maintain the cover in the locked position. For example, in some embodiments, the wristband may include an opening 140 into which a tool must be inserted to remove the cover from the housing. In such embodiments, once the cover is attached to the housing, the cover may not be removable via simply a user's hand. In some embodiments, both the child safety measures and the original lock must be engaged to open the cover.

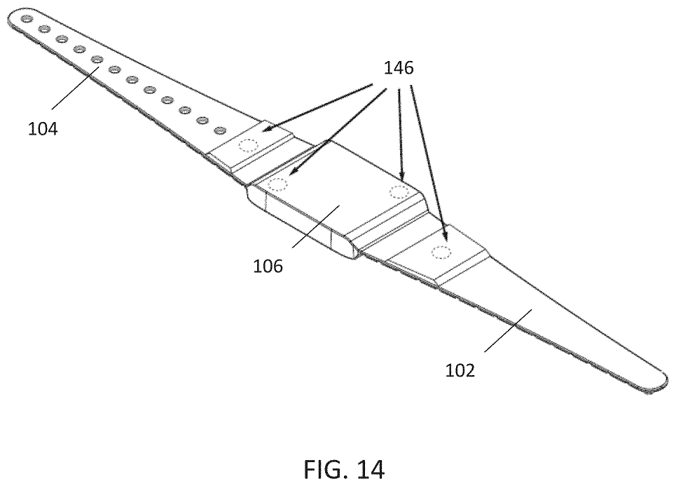

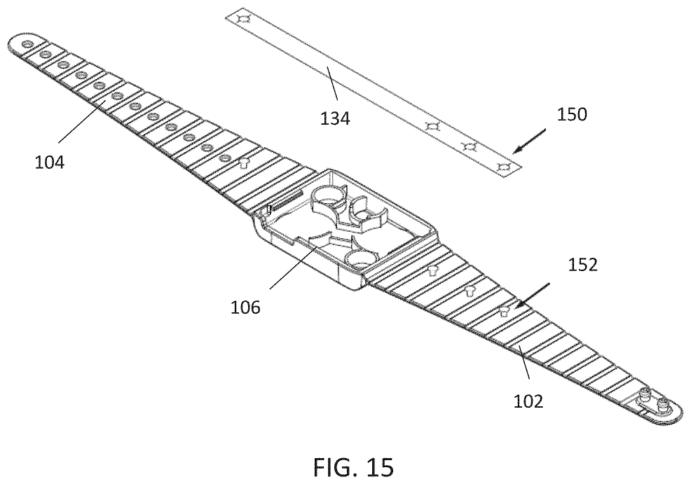

FIGS. 13-15 illustrate other ways in which electronic components may be attached to the bracelet. FIG. 13 depicts an example in which electronic components are inserted into a housing and first and second chambers 142, 144 which are formed on first and second band segments 102, 104, respectively. As shown in FIG. 14, providing additional chambers in which electronic components may be store may, for example, enable a wristband to include LEDs in both the housing 106 and the band segments 102, 104. As shown in FIG. 15, in other embodiments, electronic components 134 may engage with one or both of band segments 102, 104 to attach to the wristband. In the specific example shown, openings 150 are provided which engage with corresponding snaps 152 on first and second band segments 102, 104 to attach electronic components to the first and second band segments 102, 104. In the example shown, a cover may thereafter be used to protect at least some of the components.

In accordance with some embodiments, a wristband may be formed via injection molding. In some embodiments, the wristband may be formed of material comprising polylactic acid (PLA), polybutylene succinate (PBS), polybutylene adipate terephthalate (PBAT), polycaprolactone (PCL), and/or polyvinyl alcohol (PVA), one or more other materials, and/or combinations thereof.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An apparatus adapted to be worn by a wearer, the apparatus comprising:
a housing arranged to store one or more electronic components;
a first band segment attached to a first portion of the housing; and
a second band segment attached to a second portion of the housing;
wherein:
each of the first and second band segments is formed of a material which, in the absence of one or more mechanical elements, would be sufficiently hard, stiff and/or rigid as to preclude the first and second band segments from cooperating to substantially encircle a wearer's wrist; and
at least one of the first and second band segments comprises one or more mechanical elements to allow the first and second band segments to cooperate to substantially encircle the wearer's wrist.

2. The apparatus of claim 1, wherein the one or more mechanical elements comprise depressions on a surface of the at least one of the first and second segments.

3. The apparatus of claim 1, wherein the one or more depressions serve as one or more living hinges.

4. The apparatus of claim 2, wherein the one or more depressions are formed in a first side of each of the first and second band segments, the first side being adapted to contact the wearer's wrist when the apparatus is worn by the user.

5. The apparatus of claim 4, wherein the one or more depressions each comprise a channel.

6. The apparatus of claim 5, wherein at least one of the channels extends between a first edge and a second edge of a respective band segment.

7. The apparatus of claim 5, wherein at least one of the channels extends part of the way between a first edge and a second edge of a respective band segment.

8. The apparatus of claim 5, wherein a depth of the one or more channels is between about 0.2 and about 1 mm.

9. The apparatus of claim 2, wherein the first band segment includes a plurality of depressions positioned along a length of the first band segment.

10. The apparatus of claim 9, wherein the plurality of depressions are spaced substantially equidistant from one another along the length of the first band segment.

11. The apparatus of claim 2, wherein the one or more depressions comprise one or more auxetic patterns.

12. The apparatus of claim 1, wherein the one or more electronic components comprises a receiver adapted to receive a signal, circuitry adapted to process the signal to generate instructions, and at least one component adapted to produce a change in state in response to receiving the instructions generated by the circuitry.

13. The apparatus of claim 12, wherein the change in state results in at least one of a visual display and a tactile response.

14. The apparatus of claim 1, further comprising a cover arranged to cooperate with the housing to hold the one or more electronic components in the housing.

15. The apparatus of claim 14, wherein the cover is hingedly attached to the housing.

16. The apparatus of claim 1, wherein the housing is integrally formed with the first and second band segments.

17. The apparatus of claim 1, wherein the housing is fixedly attached to the first and second band segments.

18. The apparatus of claim 1, wherein the housing and the first and second band segments are formed of one or more of polylactic acid (PLA), polybutylene succinate (PBS), polybutylene adipate terephthalate (PB AT), polycaprolactone (PCL), and polyvinyl alcohol (PVA).

19. An apparatus adapted to be worn by a wearer, the apparatus comprising:
a housing arranged to store one or more electronic components;
a first band segment attached to a first portion of the housing; and
a second band segment attached to a second portion of the housing;
wherein the first and second band segments are formed of a material having a hardness of at least 45, and at least one of the first and second band segments includes one or more mechanical elements to allow the first and second band segments to cooperate to substantially encircle the wearer's wrist.
